(19) United States
(12) Patent Application Publication
(10) Pub. No.: US 2011/0192358 A1
(43) Pub. Date: Aug. 11, 2011

(54) DEVICE INCLUDING A PRESSURE SENSOR FOR MEASURING PRESSURES IN AN INTERNAL COMBUSTION ENGINE, AND BODY FOR SUCH A DEVICE

(75) Inventors: Alain Ramond, Merville (FR); John Burrows, Northwich Cheshire (GB); Sandro Goretti, Rubiera (RE) (IT)

(73) Assignees: CONTINENTAL AUTOMOTIVE FRANCE, Toulouse (FR); FEDERAL-MOGUL ITALY SRL, Carpi (MO) (IT)

(21) Appl. No.: 13/062,385

(22) PCT Filed: Sep. 4, 2009
(86) PCT No.: PCT/FR09/01060

§ 371 Date: Apr. 29, 2011

(30) Foreign Application Priority Data
Sep. 8, 2008 (FR) 08/04921

(51) Int. Cl. F02B 77/00; G01M 15/08

(52) U.S. Cl. 123/2; 73/114.18

(57) ABSTRACT

A device for measuring pressures inside an internal combustion engine, includes an outer housing having: a first tubular area (16) in which a lug (4) is received and a second tubular area (40) having an outer diameter larger than that of the first tubular area (16), the second tubular area (40) including an element (12) for securing the same in a bore as well as a conical bearing surface (36). The conical bearing surface (36) is formed at the end of an annular skirt (38) defining an extension of the second tubular area (40) and surrounding the first tubular area (16) while leaving a free gap (44) between the skirt (38) and the first tubular area (16).

The present invention concerns a device integrating a pressure sensor for measuring pressures in an internal combustion engine and a body of such a device.

In an internal combustion engine, in particular a Diesel engine, each cylinder typically has a glow plug for heating the interior of the corresponding combustion chamber, in particular when starting the engine. This glow plug is disposed in a threaded bore that passes through the cylinder head of the engine. This glow plug therefore includes a threaded body adapted to be fitted into the corresponding bore of the cylinder head and a finger in which a preheating electrode is housed.

It is also known to integrate a pressure sensor into such a glow plug. Indeed, it has been noticed that a knowledge of the value of the pressure inside each cylinder made it possible to improve control of the combustion in the engine. This information is then used to regulate the injection of fuel into each of the cylinders. In this way, pollutant emissions from the engine can be reduced and fuel consumption optimized.

In prior art glow plugs integrating a pressure sensor, the latter is often housed in a portion of the body of the glow plug called the glow plug head or mounted on the glow plug head. The latter is the portion of the body of the glow plug that is outside the cylinder. The document EP-1 096 141 discloses one such glow plug, for example.

In these glow plugs, it is necessary to transmit the pressure in the corresponding cylinder in the engine to the pressure sensor disposed outside the engine, in or on the glow plug head. Various assemblies have been described such that the forces exerted on the finger of the glow plug situated in the cylinder are passed on to the pressure sensor. Various mechanical parts are then inserted between the pressure sensor and the finger of the glow plug. These various intermediary parts influence the measurement made.

The document FR-2 884 299 proposes a glow plug including a tubular body with a glow plug head and a fixing zone for fixing it into a bore, a finger mounted on the body of the glow plug at the opposite end to the glow plug head, and a pressure sensor. In such glow plugs, the finger is fixed to the glow plug body so as to be fastened thereto in a connecting zone, and the glow plug body has between its connecting zone connected to the finger and its zone for fixing it into a bore an elastically deformable part such that said connecting zone is movable and can be moved longitudinally relative to the zone for fixing it into a bore that is assumed to be fixed. The pressure sensor is disposed between a member fastened to the connecting zone and a fixed member of the glow plug.

In this way, the elastically deformable part acts as a membrane that divides the body of the glow plug into two parts, a fixed part intended to be mounted in a cylinder head and a movable part subjected to the pressure in a cylinder of the corresponding engine. This membrane can be deformed and the movable part can be moved longitudinally. That movement, which depends on the pressure in the cylinder is then transmitted to the pressure sensor, which can thus give an indication of the pressure exerted on the finger of the glow plug. With this kind of glow plug, the measurement from the pressure sensor is no longer disturbed by unwanted vibrations. Indeed, the movement of the membrane is not affected by the stresses in the cylinder head or in the rest of the body of the glow plug.

It is also known, in Diesel engines (generally large cubic capacity engines), and petrol engines, to have a dedicated device for measuring the pressure in the combustion chambers of the engine. Such a device then includes a body having means for fixing it into a cylinder head and inside which a pressure sensor is located. The present invention also relates to such pressure measuring devices. In the remainder of the description, when plugs or glow plugs are referred to, pressure measuring devices are also concerned, which are sometimes known as SAPS (Stand Alone Pressure Sensors), but for simplicity these are not explicitly mentioned.

A glow plug is fitted, as indicated above, by screwing the glow plug into a threaded bore. To provide a seal, an abutment is provided at the end of screwing. This abutment is conical and receives a bearing cone produced on the body of the glow plug. The conical surface of the abutment produced in the cylinder head generally corresponds to a slightly narrower cone (half-angle at the apex around three degrees less, for example) than that of the bearing surface produced on the body of the glow plug. Furthermore, the material used to produce the glow plug body is harder than that from which the cylinder head is made. Thus when the glow plug is screwed into its corresponding threaded bore, the glow plug body crushes the abutment of the cylinder head and produces an imprint.

If the glow plug is removed and then refitted or replaced, a new imprint is created because even if the glow plug that has just been removed is refitted, on screwing the glow plug into its housing there is little chance of the bearing surface of the glow plug body returning to be housed in the same imprint. The bearing surface therefore varies on replacing the glow plug or refitting a glow plug that has just been removed. The tightening torque exerted on the glow plug creates forces on the abutment with a radial component and a longitudinal component because of the conical nature of the bearing. These forces vary with the tightening torque, of course, but also as a function of the bearing surface (in mm2). Thus by retaining the same tightening torque, for example using a torque wrench, the radial and longitudinal clamping forces will vary because of the variation of the bearing surface. It has been found that these variations influenced the measurements produced by the sensor integrated into the glow plug.

Another problem encountered when a new imprint is created each time that a glow plug is fitted is that the seal produced between the glow plug body and the cylinder head is degraded. The pressures in the combustion chambers being very high, a good contact and a relatively large (and most importantly continuous) contact surface must be ensured, to obtain a good seal and to avoid loss of compression in the corresponding engine.

Thus one object of the present invention is to provide means for optimum measurement of the pressure inside a cylinder of an internal combustion engine without being influenced in particular by fitting and removing a glow plug integrating a pressure sensor (or a stand-alone pressure sensor).

Another object of the invention is to provide means for ensuring a good seal between the body of the glow plug and the cylinder head.

To this end, the invention provides a device integrating a pressure sensor for measuring pressures in an internal combustion engine including an exterior envelope having:
a first tubular zone in which a finger is intended to be placed, and
a second tubular zone of greater outside diameter than the first tubular zone, this second tubular zone having means for fixing it into a bore and a conical bearing surface.

In the present invention, the conical bearing surface is produced at the end of an annular skirt extending the second tubular zone and surrounding the first tubular zone, leaving a free space between said skirt and the first tubular zone.

Thus the bearing surface is no longer a beveled shoulder produced on the exterior surface of a glow plug body or the like. Producing this bearing surface at the free end of a skirt provides better control over the dimensions of the bearing surface and therefore also of the bearing surface that comes into contact with a corresponding abutment.

The present invention is particularly well suited to devices integrating a pressure sensor such as those described hereinabove and for which the first tubular zone and the second tubular zone are connected to each other by a wall extending substantially radially and forming an elastic membrane. In such a device, the first tubular zone and the membrane preferably form only one part, said part having at least one zone of the same outside diameter as the second tubular zone. The elastic membrane here is such that it provides the mechanical connection between the first tubular zone and the second tubular zone. Its elasticity makes it possible to give a degree of freedom (axial movement along the axes—which coincide—of the two tubular zones) for the first tubular zone and thus for the finger, relative to the second tubular zone that is assumed to be fixed.

Similarly, the invention preferably more particularly concerns devices integrating a pressure sensor in which the first tubular zone and the second tubular zone are formed as a single part.

The bearing surface (in mm2) depends in particular on the tightening torque to be applied to the device integrating a pressure sensor and the corresponding cylinder head. The bearing surface and the torque may be adapted to obtain a desired stress. In some embodiments of a device of the invention, the conical bearing surface is limited with respect to the width of the annular skirt, in particular when the bearing surface must be relatively small. In a preferred embodiment, provision is made in particular for the thickness of the wall forming the skirt to be at most equal to the thickness of the wall of the second tubular zone. This makes it possible to have a reduced surface.

In this kind of situation (surface limitation), in a first variant, over at least part of its height the annular skirt has at the opposite end to the second tubular zone of the exterior body a portion of smaller outside diameter than said second tubular zone, and the conical bearing surface is formed in this smaller outside diameter portion of the skirt. A second variant embodiment provides that over at least part of its height, the annular skirt has, on the opposite side to the second tubular zone of the exterior body, a part of greater inside diameter than the inside diameter of said second tubular zone, and that the conical bearing surface is formed in that part of the skirt of greater inside diameter.

Another variant, where appropriate combinable with one of the preceding variants, provides for the conical bearing surface to be contiguous with another conical surface oriented toward the first tubular area.

In a device of the invention for measuring the pressure in a combustion chamber, there is for example provision for a finger, where appropriate a heating finger, to be fastened to the exterior body in the first tubular zone in being joined to that zone. In an embodiment of this kind, the pressure sensor can then be mounted between a bearing part fixed relative to the second tubular zone and a part attached to the finger, movable with the first tubular zone, the second tubular zone being considered fixed.

The present invention also relates to an exterior body of a device for measuring pressures in an internal combustion engine, said body having:
a first tubular zone in which a finger is intended to be placed, and
a second tubular zone of greater outside diameter than the first tubular zone, this second tubular zone having means for fixing it into a bore and a conical bearing surface.

In the present invention, the conical bearing surface is produced at the end of an annular skirt extending the second tubular zone and surrounding the first tubular zone, leaving a free space between said skirt and the first tubular zone.

In this kind of exterior body, it is particularly advantageous if the first tubular zone and the second tubular zone are connected together by a wall extending substantially radially and forming an elastic membrane and if the conical bearing surface is limited relative to the width of the annular skirt.

An exterior body according to the present invention is preferably formed as a single part by machining.

Finally, the present invention relates to an internal combustion engine characterized in that it includes a device as described hereinabove.

Details and advantages of the present invention will emerge more clearly from the following description, given with reference to the appended diagrammatic drawings, in which:

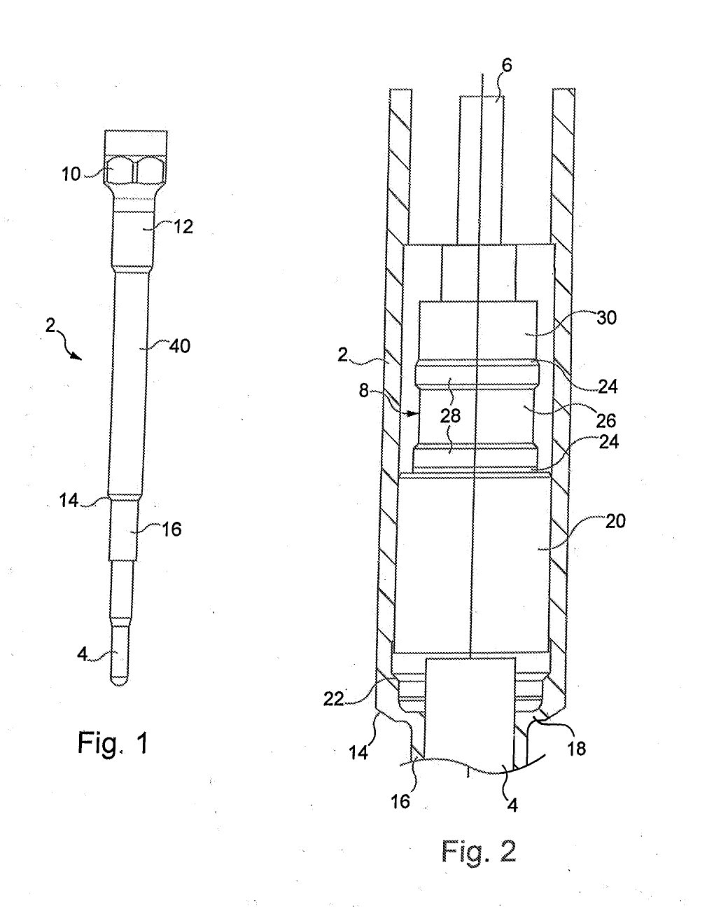

FIG. 1 is an exterior view of a prior art glow plug,

FIG. 2 is a partial view to a larger scale in which the exterior body of the glow plug has been cut away to show a pressure sensor and a seat for the prior art glow plug from FIG. 1, and

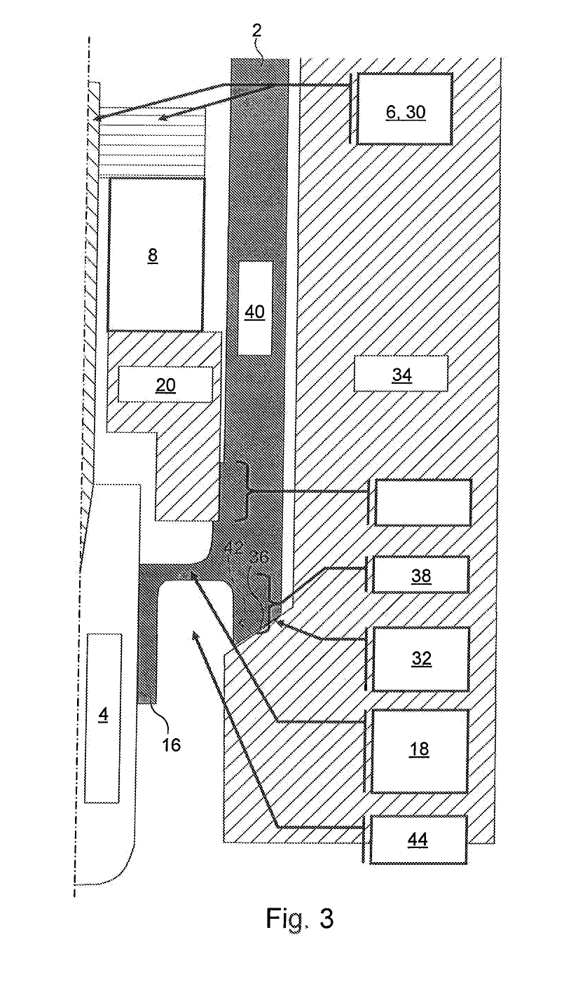

FIG. 3 is a diagrammatic half-view in longitudinal section of a device of the invention integrating a pressure sensor mounted in a cylinder head and showing a pressure sensor and the bearing of the device on a conical seat of the cylinder head.

The following description is given with reference to a glow plug integrating a pressure sensor. However, the invention described here relates equally to pressure measuring devices sometimes referred to as stand alone pressure sensors (SAPS). This type of device is used in Diesel engines (generally large cubic capacity engines) and petrol engines, for example, to measure the pressure in the combustion chambers of the engine without being integrated into a glow plug or spark plug. A dedicated well is then provided for fitting the device for each combustion chamber concerned.

The prior art glow plug represented in FIGS. 1 and 2 is the glow plug disclosed in the document FR 2 884 299. This glow plug includes in a manner known to the person skilled in the art a body 2, a finger 4, a core 6 and a pressure sensor 8.

The body 2 is of tubular shape and features a plurality of circular cylindrical segments. At a first end, called the glow plug head 10, the glow plug body has a holding zone with an exterior surface of hexagonal cross section. This holding zone is used for fitting and removing the glow plug by screwing/unscrewing it. For fitting it, a threaded zone 12 is provided adjacent to the glow plug head 10. A corresponding thread is provided in a cylinder head of an engine to cooperate with the threaded zone 12. To perfect the seal between the cylinder head and the glow plug, there is also provision for forming a sealing cone 14 on the body 2. This cone cooperates with a complementary conical surface formed in the cylinder head and through shapes that fit together provides an excellent seal between the two parts.

On the opposite side to the glow plug head, the glow plug body 2 carries the latter's finger 4. This finger is intended to be placed in a combustion chamber of the corresponding engine. This finger 4 forms the heating element of the glow plug.

As represented in the drawings, the finger 4 is preferably a ceramic finger. This type of finger is known to the person skilled in the art and is not described in more detail here. It produces a small heating element. The finger 4 could also be a metallic finger. This finger 4 is fed with electrical current by the core 6 that passes through the body 2 of the glow plug. In the region of the glow plug head 10, a connection (not shown) is provided for connecting the core 6 to a source of electrical current.

The opposite end of the glow plug body 2 to the glow plug head carries the finger 4. This end is a zone of circular cylindrical section the inside diameter of which is adapted to the outside diameter of the finger 4. The finger 4 is brazed to the end 16 of the glow plug body 2, for example. The brazing can be effected over the entire height of the end 16 the diameter whereof is adapted to the diameter of the finger 4. Brazing fastens the finger 4 to the end 16 of the glow plug body 2. Other techniques could be used here to fasten the finger 4 to the end 16 of the body 2. The lower part of the glow plug body 2 comprising the end 16 can be made from a material suitable for brazing. This material preferably has a coefficient of expansion close to that of the ceramic used to produce the finger 4. Thus the glow plug body 2 can be an assembly of several parts. Note that the body 2 represented in FIG. 2 includes a junction plane corresponding to the assembly of two parts welded to each other to form the body 2.

The end 16 of the glow plug body 2 forms a connecting zone between the glow plug body 2 and the finger 4. This connecting zone is connected to the rest of the glow plug body 2 by an elastically deformable part of the body, this elastic part being called the membrane 18 hereinafter. The connection of the end 16 to the rest of the glow plug body 2 is effected, through the intermediary of the membrane 18, in the region of the sealing cone 14. The membrane provides a mechanical connection while leaving a degree of freedom corresponding to an axial movement of the end 16 relative to the body of the plug.

The membrane 18 takes the form of an annular washer disposed in a plane perpendicular to the axis of the glow plug body 2. The thickness of the membrane (measured in the longitudinal direction) is of the order of 0.3 mm, for example. This thickness is less than the thickness of the wall of the body 2. This latter thickness can be from 0.5 mm to 1 mm, for example. The width of this membrane 18 is of the order of 0.5 mm. In this numerical example, this means that the difference between the outside radius of the membrane 18 and the inside radius thereof is 0.5 mm.

As can be seen in FIG. 2, the large diameter outside edge of the membrane 18 is connected to the sealing cone 14. The part of the glow plug body 2 situated between the sealing cone 14 and the threaded zone 12, including that threaded zone, is a rigid zone. This zone is mounted in the corresponding cylinder head and it is assumed that it is fixed. If axial forces are exerted on the finger 4, the membrane 18 flexes and the finger 4, and likewise the end 16 of the body 2, are displaced in the longitudinal direction. Thus on one side of the membrane 18 there is a zone of the glow plug body 2 that is assumed to be fixed and on the other side a movable zone. Thus the membrane 18 decouples these two zones.

If pressure is exerted inside the corresponding cylinder, that pressure exerts on the finger 4 a force tending to cause it to move into the glow plug body 2. This pressure is measured by the pressure sensor 8. This is a piezo-electric sensor.

The pressure sensor 8 is mounted between a fixed part fastened to the immovable part of the glow plug body 2 and a movable part fastened to the finger 4.

The fixed part is called the interface 20 hereinafter. It is a tubular member of circular cylindrical shape. Its shape and its dimensions are adapted so that it can be housed inside the tubular body 2 and to provide a passage for the core 6. This interface 20 is positioned in the glow plug body 2 just above the sealing cone 14. This part is therefore very close to the finger 4. A seat 22 is provided in the interior surface of the glow plug body 2 to receive the interface 20.

The pressure sensor 8 is placed on the interface 20, i.e. on the same side as the glow plug head 10. In the conventional way, an electrically insulating member 24 is disposed between the interface 20 and the piezo-electric sensor 8. That sensor comprises a piezo-electric member 26 disposed between two contact members 28 of electrically conductive material. Each of these contact members 28 is provided with a connecting grid (generally known as a “lead frame”) that is molded over it and in the shape of a portion of a cylinder. These connecting grids are not represented in the drawing. Here more conventional connecting terminals can also be provided.

Above the pressure sensor 8 is the movable part referred to hereinabove. Here it is a ring 30. The latter is also electrically insulated from the pressure sensor 8 by means of an electrically insulating member 24. The ring 30 is welded to the core 6, for example by laser welding.

In the rest state, if no pressure is exerted on the finger 4, the pressure sensor 8 is loaded. If a pressure is exerted on the finger 4, the loading on the pressure sensor is reduced and the pressure sensor 8 measures this variation in loading.

FIG. 3 shows a glow plug of the present invention. This glow plug has the same main components described hereinabove arranged in the same way. The differences between the prior art glow plug described above with reference to FIGS. 1 and 2 and the glow plug of the invention shown in FIG. 3 concern the zone in which the glow plug body 2 bears on a seat 32 produced in a cylinder head 34, i.e. at the sealing cone 14 of the prior art.

A glow plug of the present invention includes a bearing surface 36 intended to cooperate with the seat 32 of the cylinder head 34. In an original way, this bearing surface 36 is produced at the free end of an annular skirt 38 that surrounds the upper portion of the end 16.

It is assumed in the present description that the glow plug described has a longitudinal axis disposed vertically and that the glow plug head 10 is at the top and the finger 14 at the bottom.

The bottom end 16 of the body takes the form of a first tubular zone. It receives inside it the finger 4 as described above for the prior art glow plug. In the case of a stand-alone pressure sensor, the tubular end 16 and the finger 4 are generally made of only one part.

The body 2 also has a second tubular zone 40 having a circular cylindrical exterior surface and forming with the first tubular zone, or end 16, an exterior envelope around the finger 4 and the pressure sensor 8. This kind of tubular zone is also present in the prior art glow plug of FIGS. 1 and 2. It extends between the threaded zone 12 and the zone in which the glow plug bears on the seat 32 of the cylinder head 34.

The first tubular zone corresponding to the end 16 of the body 2 and the second tubular zone 40 of the body 2 are connected together by the membrane 18. As is clear in particular from the drawing, the outside diameter of the second tubular zone 40 is greater than the outside diameter of the end 16, which also has a circular cylindrical exterior surface.

In the FIG. 3 embodiment, the skirt 38 extends the second tubular zone 40. This skirt 38 has a thickness which is at most the same as the thickness of the body in the second tubular zone 40 so that there is no risk of impeding the functioning of the membrane 18.

The thickness of the skirt—measured radially—is preferably limited so as likewise to limit the bearing surface of the body 2 bearing on the seat 32 of the cylinder head 34. This bearing surface 36 is a conical surface (or to be more precise a frustoconical surface) adapted to the shape of the seat 32. In the conventional way, the half-angle at the apex of the bearing surface 36 is greater (wider cone) than that of the seat 32. Here a half-angle at the apex of the bearing surface a few degrees greater (1 to 5 degrees greater) than the half-angle at the apex of the seat 32 can be chosen. A half-angle 3° greater can be chosen, for example.

The material chosen for producing the body of the glow plug, or at least for the skirt 38, will be harder than that used to produce the cylinder head 34. Thus when the glow plug is screwed into its bore, also known as a well, the bearing surface 36 creates an imprint in the seat 32 of the cylinder head 34. By limiting the bearing surface 36, it is ensured that on each new tightening all of the bearing surface 36 will rest on the seat 32 of the cylinder head 34. In this way, the bearing surface (in mm2) is perfectly controlled and a perfect seal is produced between the glow plug and the cylinder head.

To limit the thickness of the skirt 38, it is possible to adapt its outside diameter, or its inside diameter, or both. In the embodiment shown in FIG. 3, the outside diameter of the skirt 38 corresponds to the outside diameter of the second tubular zone 40. However, the skirt 38 having an outside diameter less than that of the second tubular zone 40 could be envisaged, either over all the height of the skirt 38 or only over its lower part, i.e. in the region of the free end of the skirt.

To limit the bearing surface 36, it is also possible to provide at the free end of the skirt 38 another conical surface oriented toward the end 16. This variant is suggested by a dashed line 42 in FIG. 3.

The height of the skirt 38, for example relative to the membrane 18, is of the order of a few millimeters at most. Its height is between 1 and 2 mm, for example.

The presence of the skirt 38 creates an annular free space 44 under the membrane 18. This free space 44 protects the membrane 18. If the cylinder head 34 is deformed, for example following excessive tightening of the glow plug onto the seat 32, or following several removals and fittings of a glow plug into the same housing, no part of the assembly risks coming into contact with the membrane 18 and interfering with its operation.

The present invention is not limited to the embodiment described hereinabove and to the variants referred to. It also concerns all variants within the capability of the person skilled in the art.

Thus, for example, all of the numerical data provided is given by way of illustrative and nonlimiting example only.

The description refers to a glow plug including an elastic membrane connecting a first tubular zone to a second tubular zone. The present invention could also apply to a glow plug having no such membrane.

The present invention can be implemented equally well with an exterior body (glow plug or SAPS) made in one piece or in several pieces.

1. Device integrating a pressure sensor (8) for measuring pressures in an internal combustion engine including an exterior envelope having:
a first tubular zone (16) in which a finger (4) is intended to be placed, and
a second tubular zone (40) of greater outside diameter than the first tubular zone (16), this second tubular zone (40) having means (12) for fixing it into a bore and a conical bearing surface (36),
characterized in that the conical bearing surface (36) is produced at the end of an annular skirt (38) extending the second tubular zone (40) and surrounding the first tubular zone (16), leaving a free space (44) between said skirt (38) and the first tubular zone (16).

2. Device according to claim 1, characterized in that the first tubular zone (16) and the second tubular zone (40) are connected together by a wall (18) extending substantially radially and forming an elastic membrane.

3. A device according to claim 2, characterized in that the first tubular zone (16) and the membrane (18) form only one part, and in that said part has at least one zone of the same outside diameter as the second tubular zone (40).

4. A device according to claim 1, characterized in that the first tubular zone (16) and the second tubular zone (40) are formed as a single part.

5. A device according to claim 1, characterized in that the thickness of the wall forming the skirt (38) is at most equal to the thickness of the wall of the second tubular zone (40).

6. Device according to claim 5, characterized in that over at least a part of its height the annular skirt (38) has at the opposite end to the second tubular zone (40) of the exterior body a portion of smaller outside diameter than said second tubular zone, and in that the conical bearing surface (36) is formed in this smaller outside diameter portion of the skirt.

7. A device according to claim 5, characterized in that over at least part of its height, the annular skirt (38) has, on the opposite side to the second tubular zone (40) of the exterior body, a part of greater inside diameter than the inside diameter of said second tubular zone, and in that the conical bearing surface (36) is formed in that part of the skirt of greater inside diameter.

8. Device according to claim 1, characterized in that the conical bearing surface (36) is contiguous with another conical surface (42) oriented toward the first tubular zone (16).

9. Device according to claim 1, characterized in that a finger (4), where appropriate a heating finger, is fastened to the exterior body (2) in the first tubular zone (16) in being joined to that zone.

10. Device according to claim 9, characterized in that the pressure sensor (8) is mounted between a bearing part (20) fixed relative to the second tubular zone (40) and a part (30) attached to the finger (4), movable with the first tubular zone (16), the second tubular zone (40) being considered fixed.

11. Exterior body (2) of a device for measuring pressures in an internal combustion engine, said body having:
a first tubular zone (16) in which a finger (4) is intended to be placed, and
a second tubular zone (40) of greater outside diameter than the first tubular zone (16), this second tubular zone (40) having means (12) for fixing it into a bore and a conical bearing surface (36),
characterized in that the conical bearing surface (36) is produced at the end of an annular skirt (38) extending the second tubular zone (40) and surrounding the first tubular zone (16), leaving a free space between said skirt (38) and the first tubular zone (16).

12. Exterior body (2) according to claim 11, characterized in that the first tubular zone (16) and the second tubular zone (40) are connected together by a wall (18) extending substantially radially and forming an elastic membrane and in that the conical bearing surface (36) is limited relative to the width of the annular skirt (38).

13. An exterior body (2) according to claim 11, characterized in that it is a single machined part.

14. Internal combustion engine, characterized in that it includes a device according to claim 1.

15. A device according to claim 2, characterized in that the first tubular zone (16) and the second tubular zone (40) are formed as a single part.

16. A device according to claim 2, characterized in that the thickness of the wall forming the skirt (38) is at most equal to the thickness of the wall of the second tubular zone (40).

17. Device according to claim 2, characterized in that the conical bearing surface (36) is contiguous with another conical surface (42) oriented toward the first tubular zone (16).

18. Device according to claim 2, characterized in that a finger (4), where appropriate a heating finger, is fastened to the exterior body (2) in the first tubular zone (16) in being joined to that zone.
